(19) United States
(12) Patent Application Publication
(10) Pub. No.: US 2014/0196560 A1
(43) Pub. Date: Jul. 17, 2014

(54) AUTOMATIC TRANSMISSION SYSTEM FOR BICYCLE

(71) Applicant: Jian-Hong Lai, Taichung City (TW)

(72) Inventor: Jian-Hong Lai, Taichung City (TW)

(21) Appl. No.: 13/740,296

(22) Filed: Jan. 14, 2013

(51) Int. Cl. F16H 61/68

(52) U.S. Cl. CPC F16H 61/68
USPC 74/473.12

(57) ABSTRACT

The invention includes a wheel speed detector, disposed beside a wheel of the bicycle for detecting a rotational speed of the wheel; a crankset forward rotation detector, disposed beside a crankset of the bicycle for detecting forward rotational speed of the crankset; a control module, attached on a handle bar of the bicycle, having a display, an operation interface and a program, and electrically connected to the wheel speed detector and the crank forward rotation detector for receiving sensing signals therefrom and outputting control signals; a gear change driver, electrically connected to the control module for receiving the control signals and driving at least one derailleur of the bicycle to change gears; and a power supply, having a battery to supply electric power to the automatic transmission system.

### BACKGROUND OF THE INVENTION

1. Technical Field

The invention relates to transmissions of bicycles, particularly to automatic electric transmissions.

2. Related Art

In recently years, bicycling becomes a worldwide popular form of recreation, sport and transportation. Depending upon different purposes of bicycling, there are many kinds of bicycles, such as road bikes, mountain bikes, folding bikes, etc. Whether bicycles are used for recreation, transportation or competition, the bicycle industry always keeps improving all components bicycle. An important part of a bicycle is the transmission system, as known as drivetrain system. Drivetrain systems of modern bicycles are provided with more and more speeds, such as 27-speed and 30-speed.

Conventional bicycle drivetrain systems are hand-operated. However, not all users can manually operate it very well or even do not know how to operate it. Riding will become hard if the drivetrain system cannot be set at a correct gear. Thus this is a real problem to be solved.

### SUMMARY OF THE INVENTION

An object of the invention is to provide an automatic transmission system for a bicycle, which can automatically change gears according to wheel speed and crankset speed without a manual operation.

To accomplish the above object, The automatic transmission system of the invention includes a wheel speed detector, disposed beside a wheel of the bicycle for detecting a rotational speed of the wheel; a crankset forward rotation detector, disposed beside a crankset of the bicycle for detecting forward rotational speed of the crankset; a control module, attached on a handle bar of the bicycle, having a display, an operation interface and a program, and electrically connected to the wheel speed detector and the crank forward rotation detector for receiving sensing signals therefrom and outputting control signals; a gear change driver, electrically connected to the control module for receiving the control signals and driving at least one derailleur of the bicycle to change gears; and a power supply, having a battery to supply electric power to the automatic transmission system.

### BRIEF DESCRIPTION OF THE DRAWING

FIG. 1 is a block diagram of the invention.

### DETAILED DESCRIPTION OF THE INVENTION

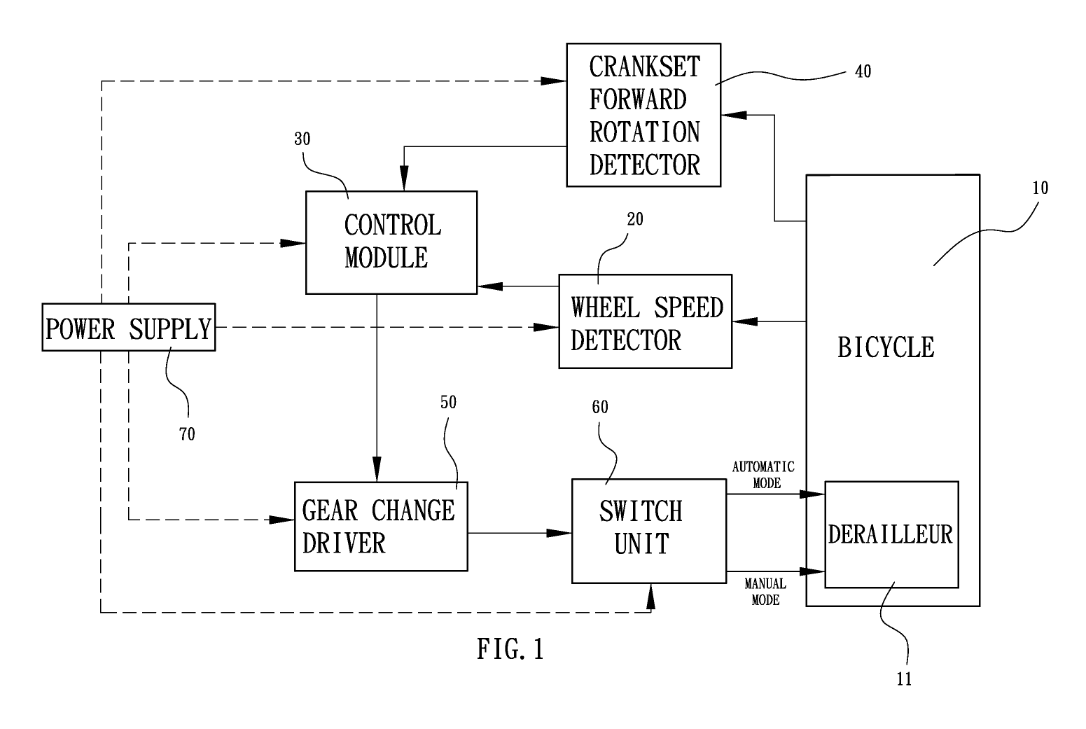

Please refer to FIG. 1. The automatic transmission system for a bicycle 10 of the invention includes a wheel speed detector 20, a crankset forward rotation detector 40, a control module 30, a gear change driver 50 and a power supply 70.

The wheel speed detector 20 is disposed beside a wheel of the bicycle 10 for detecting a rotational speed of the wheel.

The crankset forward rotation detector 40 is disposed beside a crankset of the bicycle 10 for detecting forward rotational speed of the crankset. The forward rotation means a rider is treading on pedals to move forward.

The control module 30 is attached on a handle bar of the bicycle and has a display, an operation interface and a program. The control module 30 is electrically connected to the wheel speed detector 20 and the crank forward rotation detector 40 for receiving sensing signals therefrom and outputting control signals. The control signals vary depending upon the received sensing signals.

The gear change driver 50 is electrically connected to the control module 30 for receiving the control signals and driving one or two derailleurs 11 of the bicycle 10 to change gears. The gear change driver 50 will be activated only when the crankset is rotating forward.

Preferably, the invention may further be provided with a switch unit 60 disposed between the gear change driver 50 and the derailleurs 11 for selecting an automatic mode or a manual mode. When the manual mode is selected, the automatic transmission system will cease its automatic function.

The power supply 70 may be a battery to supply electric power to the automatic transmission system.

The gear change driver 50 may be divided into two sets separately disposed beside two derailleurs.

The control module 30 is further provided with a detachable mechanism for removing from the bicycle.

A memory, integrated circuit (IC) board or IC of the control module 30 may be detachable.

The gear change driver 50 may be a combination of a servo motor, a gear set and a spindle, through which the derailleur 11 can be driven to change position.

The control module 30 can be input with parameters such as wheel size and exercise grade including child, youth, woman, old man, ace and master.

The control module 30 can be input with options such as float road, gravel, mire, mandatory upshift, mandatory no shift and mandatory downshift.

It will be appreciated by persons skilled in the art that the above embodiment has been described by way of example only and not in any limitative sense, and that various alterations and modifications are possible without departure from the scope of the invention as defined by the appended claims.

What is claimed is:

1. An automatic transmission system for a bicycle, comprising:
a wheel speed detector, disposed beside a wheel of the bicycle for detecting a rotational speed of the wheel;
a crankset forward rotation detector, disposed beside a crankset of the bicycle for detecting forward rotational speed of the crankset;
a control module, attached on a handle bar of the bicycle, having a display, an operation interface and a program, and electrically connected to the wheel speed detector and the crank forward rotation detector for receiving sensing signals therefrom and outputting control signals;
a gear change driver, electrically connected to the control module for receiving the control signals and driving at least one derailleur of the bicycle to change gears; and
a power supply, having a battery to supply electric power to the automatic transmission system.

2. The automatic transmission system of claim 1, further comprising a switch unit between the gear change driver and the at least one derailleur for selecting an automatic mode or a manual mode.

3. The automatic transmission system of claim 1, wherein the gear change driver is divided into two sets separately disposed beside two derailleurs.

4. The automatic transmission system of claim 1, wherein the control module is further provided with a detachable mechanism for removing from the bicycle.

5. The automatic transmission system of claim 1, wherein a memory, integrated circuit (IC) board or IC of the control module is detachable.

6. The automatic transmission system of claim 1, wherein the gear change driver is a combination of a servo motor, a gear set and a spindle, through which the at least one derailleur can be driven to change position.

7. The automatic transmission system of claim 1, wherein the control module is capable of being input with parameters including wheel size and exercise grade.

8. The automatic transmission system of claim 1, wherein the control module is capable of being input with options including float road, gravel, mire, mandatory upshift, mandatory no shift and mandatory downshift.
